(19) United States
(12) Patent Application Publication
(10) Pub. No.: US 2023/0030433 A1
(43) Pub. Date: Feb. 2, 2023

(54) SYSTEM AND METHOD FOR ADDING AND SIMULTANEOUSLY DISPLAYING AUXILIARY CONTENT TO MAIN CONTENT DISPLAYED VIA A GRAPHICAL USER INTERFACE (GUI)

(71) Applicant: APP-POP-UP INC., Winnipeg (CA)

(72) Inventors: Rajeev KUMAR, Disraeli (CA); Rakesh KUMAR, Disraeli (CA)

(21) Appl. No.: 17/872,149

(22) Filed: Jul. 25, 2022

Related U.S. Application Data
(63) Continuation-in-part of application No. 17/561,261, filed on Dec. 23, 2021, now Pat. No. 11,474,769.
Application No. 17/561,261 is a continuation-in-part of application No. 17/443,563, filed on Jul. 27, 2021.

(51) Int. Cl. G06T 11/00

(52) U.S. Cl. CPC G06T 11/00; G06T 2200/24; G06T 2210/62

(57) ABSTRACT

A system and method provide for adding auxiliary content to main content for simultaneous display therewith via the same graphical user interface. The system comprises a user device and system controller. The user device an interface display for displaying the graphical user interface. The system controller is in operative communication with the user display device. The system controller determines if the main content is being displayed via the interface display, selectively adds the auxiliary content to the displayed main content for simultaneous display therewith via the interface display and provides for the user to input a command via the user display device for modulating displaying of the auxiliary content via the interface display.

### CROSS-REFERENCE TO RELATED APPLICATIONS

The present application is a Continuation in part and claims benefit of U.S. patent application Ser. No. 17/561,261 filed on Dec. 23, 2021 and which is a Continuation in part and claims benefit of U.S. patent application Ser. No. 17/443,563 filed on Jul. 27, 2021 both of which are incorporated herein by reference in their entirety.

### TECHNICAL FIELD

The present disclosure generally relates to computer graphical user interfaces (GUIs) including touch-displays. More particularly, but not exclusively, the present disclosure relates to a system and method for adding and simultaneously displaying auxiliary content to main content displayed via a GUI. More particularly, but still not exclusively, the auxiliary content includes images, command input images and/or interfaces and adding includes superimposing and/or integrating the auxiliary content over or within the main content being displayed.

### BACKGROUND

Computer graphical user interfaces using touch touch-displays are widely used on a daily basis on mobile units, tablets, laptops, PCs and other computers for a variety of purposes including streaming material for entertainment, educational or business purposes such as transactions including purchasing. Touch display screens can be capacitive or resistive. Resistive screens rely on applied pressure which means that sometimes the tip of a pen or another object can initiate a response from the system. Capacitive touch screens use electrical conductors rather than pressure to recognize a command and respond. Capacitive touch screens depend on a specific amount of electrical charge to get a response from the operating system. This electrical charge can be provided by the user's bare fingers or special styluses, gloves, and the like.

Merchants provide users with graphical user interfaces to view article or service information and to proceed to purchase. The merchant-provided user interfaces as usually “busy” with clickable material and adds as merchants are always trying to capture the attention of potential customers streaming in an online marketplace. One of the challenges merchants have is incentivizing users to view advertising material during live streams (such as sports, concerts and other events).

### OBJECTS

An object of the present disclosure is to provide a system for adding and simultaneously displaying auxiliary content to main content displayed via a GUI.

An object of the present disclosure is to provide a method for adding and simultaneously displaying auxiliary content to main content displayed via a GUI.

### SUMMARY

In accordance with an aspect of the disclosure, there is provided a system for adding auxiliary content to main content for simultaneous display therewith via the same graphical user interface, wherein the main content and auxiliary content are hosted by one or more remote host controllers, the system comprising: a user device in operative communication with the one or more remote host controllers and comprising an interface display for displaying the graphical user interface containing the simultaneously displayed main content and auxiliary content; a system controller in operative communication with the user display device and the one or more remote host controllers, the system controller having a processor with an associated memory of processor executable code that when executed provides the system controller with performing computer-implementable steps comprising: determining whether the main content is being displayed via the interface display; selectively adding the auxiliary content to the displayed main content for simultaneous display therewith via the interface display, wherein the step of adding comprises at least one of: superimposing the auxiliary content on the main content; integrating the auxiliary content to the main content; and providing for the auxiliary content to underly the main content and be visible therethrough; and providing for the user to input a command via the user display device for modulating displaying of the auxiliary content via the interface display.

In an embodiment, the computer-implementable steps further comprise positioning the auxiliary content on a selected portion of the main content. In an embodiment, the selected portion comprises a background of the main content or an area of the main content devoid of foreground activity.

In an embodiment, the auxiliary content comprises a visual representation selected from the group consisting of an image, an input command image, an application icon, an interface, and any combination thereof.

In an embodiment, the auxiliary content is smaller in size than the main content.

In an embodiment, selectively adding the auxiliary content to the main content is provided without re-sizing the main content.

In an embodiment, when the auxiliary content is superimposed on a portion of the main content, the auxiliary content covers and obscures the portion.

In an embodiment, the auxiliary content is superimposed on a portion of the main content, the auxiliary content being translucent providing for the portion to be visible therethrough.

In an embodiment, the computer implementable step of modulating displaying of the auxiliary content comprises one or more of the following: removing the auxiliary content from the main content; repositioning the auxiliary content on the main content; splitting the graphical user interface into two sub-graphical user interfaces simultaneously displayed side by side via the interface display, wherein one of the two sub-graphical user interfaces comprises the main content and the other of the two sub-graphical user interfaces comprises the auxiliary content.; switching the main content with the auxiliary content; transforming the auxiliary content from covering and obscuring a portion of the main content to being translucent and providing this portion to be visible therethrough; transforming the auxiliary content from being translucent to being opaque for covering and obscuring a portion of the main content; resizing the auxiliary content; replacing the main content and any combination thereof.

In an embodiment, the auxiliary content comprises one or more auxiliary content visual representations hosted on a respective one of the remote host controllers. In an embodiment, one of the one of more remote host controllers hosts the main content and another of the one or more host controllers hosts the auxiliary content.

In accordance with an aspect of the present disclosure, there is provided a computer implementable method for adding auxiliary content to main content for simultaneous display therewith via the same graphical user interface, the method comprising: providing an interface display for displaying the graphical user interface containing the simultaneously displayed main content and auxiliary content; determining whether the main content is being displayed via the interface display; selectively adding the auxiliary content to the displayed main content for simultaneous display therewith via the interface display, wherein the step of adding comprises at least one of: superimposing the auxiliary content on the main content; integrating the auxiliary content to the main content; and providing for the auxiliary content to underly the main content and be visible therethrough; and providing for the user to input a computer implementable command for modulating displaying of the auxiliary content via the interface display.

In an embodiment of the method, modulating displaying of the auxiliary content comprises a computer implementable step selected from the group consisting of: removing the auxiliary content from the main content; repositioning the auxiliary content on the main content; switching the main content with the auxiliary content; replacing the main content with the auxiliary content; resizing the auxiliary content; splitting the graphical user interface into two sub-graphical user interfaces simultaneously displayed side by side via the interface display, wherein one of the two sub-graphical user interfaces comprises the main content and the other of the two sub-graphical user interfaces comprises the auxiliary content; transforming the auxiliary content from a visual representation covering and obscuring a portion of the main content superimposed thereby to being translucent and providing the portion to be visible therethrough, transforming the auxiliary content from being translucent to being opaque.

Other objects, advantages and features of the present disclosure will become more apparent upon reading of the following non-restrictive description of illustrative embodiments thereof, given by way of example only with reference to the accompanying drawings.

### BRIEF DESCRIPTION OF THE DRAWINGS

The following drawings form part of the present specification and present disclosure. In the appended drawings:

FIG. 1 is a schematic representation of the system for adding and simultaneously displaying auxiliary content to main content displayed via a graphical user interface in accordance with a non-restrictive illustrative embodiment of the present disclosure;

FIG. 2 is a schematic representation of the graphical user interface of the system of the disclosure simultaneously displaying main content and auxiliary content in accordance with a non-restrictive illustrative embodiment of the present disclosure;

FIG. 3 is a schematic representation of the graphical user interface of the system of the disclosure simultaneously displaying main content and auxiliary content in accordance with a non-restrictive illustrative embodiment of the present disclosure; and

FIG. 4 is a schematic representation of the graphical user interface of the system of the disclosure simultaneously displaying main content and auxiliary content in accordance with a non-restrictive illustrative embodiment of the present disclosure.

### DETAILED DESCRIPTION OF ILLUSTRATIVE EMBODIMENTS

Generally stated and in accordance with an aspect of the present disclosure, there is provided a computer-implemented system and method for adding auxiliary content to main content for simultaneous display therewith via the same graphical user interface. The main content and auxiliary content are hosted by one or more remote host controllers. The system comprises a user device and system controller. The user device in operative communication with the one or more remote host controllers and comprises an interface display for displaying the graphical user interface containing the simultaneously displayed main content and auxiliary content. The system controller is in operative communication with the user display device and the one or more remote host controllers. The system controller has a processor with an associated memory of processor executable code that when executed provides the system controller with performing computer-implementable steps. The system controller determines if the main content is being displayed via the interface display, selectively adds the auxiliary content to the displayed main content for simultaneous display therewith via the interface display and provides for the user to input a command via the user display device for modulating displaying of the auxiliary content via the interface display. The step of adding comprises at least one of superimposing the auxiliary content on the main content, integrating the auxiliary content to the main content, and providing for the auxiliary content to underly the main content and be visible therethrough.

In an embodiment, the system and method provide for adding an auxiliary content visual representation such as an image, an input command image, an icon, an interface including a chatbot to main content such streamed content, videogame content, websites and the like. The auxiliary content visual representation is smaller than the main content. The main content is not re-sized when the auxiliary content visual representation is added. The auxiliary content visual representation can be superimposed on the main content. Indeed a layer of auxiliary content can be superimposed on a layer of main content. it can be integrated within the main content (i.e. “ingested”) and it can underly the main content i.e. be positioned beneath main content and be visible therethrough. The auxiliary content visual representation allows third party merchants to selectively advertise and interface with users while other content is being streamed. A user can watch a sporting event and can receive advertisement information simultaneously via the auxiliary content visual representation. The user can open the visual representation or open an interface in order to transact with the merchant. The user via input commands can modulate the displaying of the auxiliary content visual representation by removing it, re-sizing it, splitting the screen and other actions as will be further discussed herein.

With reference to the drawings, non-restrictive illustrative embodiments of the present disclosure will be described so as to further exemplify the disclosure and by no means limit the scope thereof.

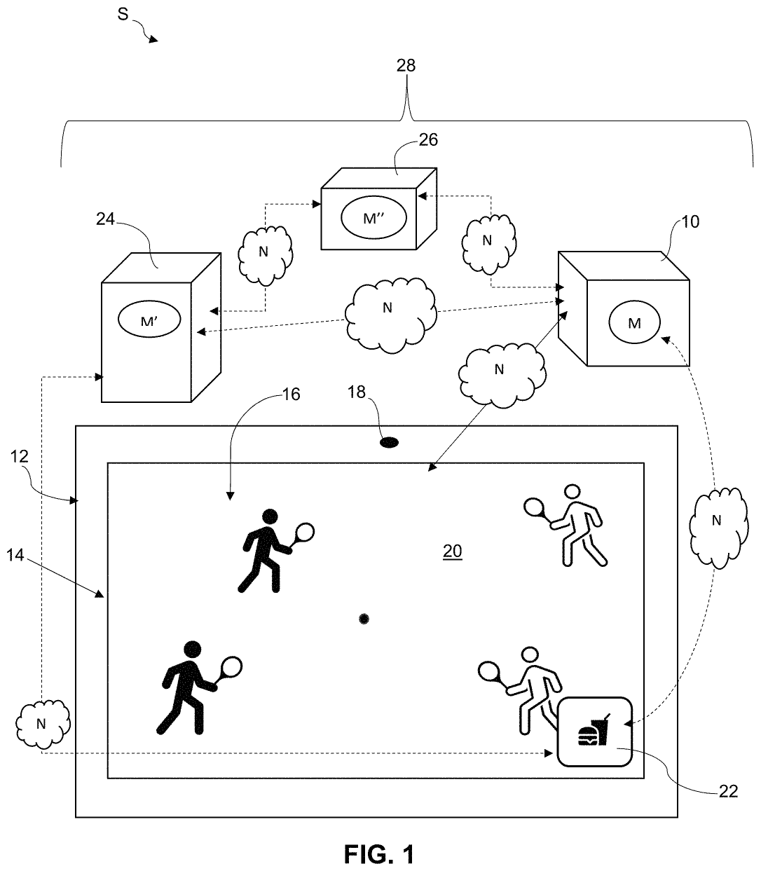

With reference to FIG. 1, there is shown remote host controller (e.g. server, data center etc.) 10 hosting a program that is being run on a user device 12 via a network N communication. The user device 12 comprises an integrated device controller (not shown), a device display screen 14 for displaying a user interface 16 and an image capturing device 18. The screen 14 and user interface 16 defining an interface display. The host controller 10 has an associated memory M of processor executable code that when executed provides for performing computer implementable steps. As such, the host controller 10 provides for streaming main content 20 via the user interface 16. In this way, controller 10 is a main content controller in accordance with the present disclosure. This main content 20 can be video content such as a video game, a movie it can be a website interactive interface and the like.

FIG. 1 shows a system S for adding and simultaneously displaying auxiliary content 22 to the main content 20 displayed via the user interface 16. The system S provides for superimposing the auxiliary content 22 onto the main content 20 and/or for integrating the auxiliary content 22 within the main content. The system S provides for underlying the auxiliary content 22 beneath the main content 20 such that it be visible therethrough. The auxiliary content 22 is provided in the form of a visual representation including images, command input images, icons, and/or interfaces. The system S comprises a system controller 24 having an associated memory M′ of controller executable code that when executed provides for performing the computer implementable step of adding the auxiliary content 22 to the main content 20 to be simultaneously displayed therewith via the interface 16.

In an embodiment, the main controller 24 is in operative communication with the display device 12 for providing the auxiliary content 22 to be displayed thereon.

In an embodiment, the system controller 24 is in operative communication via a network N with another remote host controller such as a third-party server 26 associated memory M″ of processor executable code that when executed provides for performing computer implementable steps. In an embodiment the third-party controller 26 is a merchant controller. In an embodiment, the third-party controller 26 provides the auxiliary content 22. Accordingly, the third-party acts as an auxiliary content controller 26 within the context of the present disclosure and transmits auxiliary content 22 for display to the system controller 24 which adds this auxiliary content 22 for simultaneous display via the interface display to the main content 20.

In an embodiment , the main content controller 10 is in operative communication via a network communication N with the system controller 24. The main content controller 10 can transmit the main content 20 to the system controller 24 for analysis thereof. In an embodiment, the system controller 24 can analyze the main content 20 during streaming directly onto the user device 12. In an embodiment , the system controller 24 can analyze the main content 20 directly on the main content controller 10. The foregoing main content analysis is a computer implemented step comprising steps such as determining if main content 20 is being streamed and displayed via the interface display, the type of main content displayed, determining the foreground and background of the main content 20 (via artificial intelligence recognition), determining “empty spots” of the main content, segmenting the main content into portions (as provided in U.S. Ser. No. 17/561,261 and U.S. Ser. No. 17/443,563).

Following analysis of the main content 20, the system controller 24 executes the computer implementable step of positioning the auxiliary content 22 in the user interface 16 to be displayed simultaneously with the main content 20.

In an embodiment, the remote host controller 10 is the system controller and provides both the main content 20 and the auxiliary content 22. In an embodiment, system controller 10 is in operative communication with the auxiliary content controller 26 via a network communication N for receiving the auxiliary content therefrom to be transmitted to the user device 12 as previously explained.

In an embodiment, the system controller comprises an assembly 28 of one or more controllers, such as but not limited to controllers 10, 24 and 26 in various mutual operative communication links via network communication as explained above and as can be contemplated by the skilled artisan. It should be noted that the term “system controller 24” herein is replaceable by “system controller assembly 28” and/or “system controller 10” throughout the disclosure mutatis mutandis.

Indeed, various controller combinations and assemblies can be contemplated within the context of the present disclosure. Thus, the system controller 24 is but one non-limiting example of the system controllers of system S.

In an embodiment, the main content 20 is provided by a main content controller 10 and the auxiliary content 22 is provided by an auxiliary content controller 26 with the system controller 24 providing for simultaneous display via interface 16 of the auxiliary content 22 together with the main content 20.

Turning to FIG. 1, the auxiliary content visual representation 22 is shown superimposed on the main content 20 even covering a portion of the main content 20. In an embodiment, the auxiliary content visual representation 22 is an image, an input command image, an icon, an interface and/or combinations thereof. In an embodiment, the auxiliary content controller 26 is a merchant controller and the added auxiliary content 22 provides an advertisement streamed at the same time as the main content 20 such as a movie, a sporting event, a concert, a videogame and the like. The system controller 24 provides for advertisers to advertise during streaming the main content 20 via a visual representation such as small image, an icon, or an interface.

The system controller 24 executes the computer implementable step of providing the user (i.e. the viewer) to input a command via the auxiliary content visual representation 22 including by touch commands, cursor clicks, eye orientations (e.g., Φ) as described in U.S. Ser. No. 17/443,563, voice commands and combinations thereof. In one example, the user moves the auxiliary content image 22 by finger touch in one or more directions which corresponds to respective input commands or finger taps it which corresponds to another respective input command.

The type of input commands including touch commands, cursor clicks, eye orientation commands, voice commands, and combinations thereof cause the auxiliary content visual representation 22 to change position, to be removed from view, to re-size such as enlarging so as to be more visible or being made smaller to make the main content 20 more visible, to split the interface 16 (as described in U.S. Ser. No. 17/561,261), to switch positions with the main content 20 (i.e. the main content becomes the auxiliary content 22 and the auxiliary content 22 becomes the main content 20). In an embodiment, the main content 20 is paused via input commands to view the auxiliary content 22. In an embodiment the auxiliary content 22 comprises an auxiliary interface allowing for input commands such as perusing advertised articles and making a purchase as is known in the art to be executed.

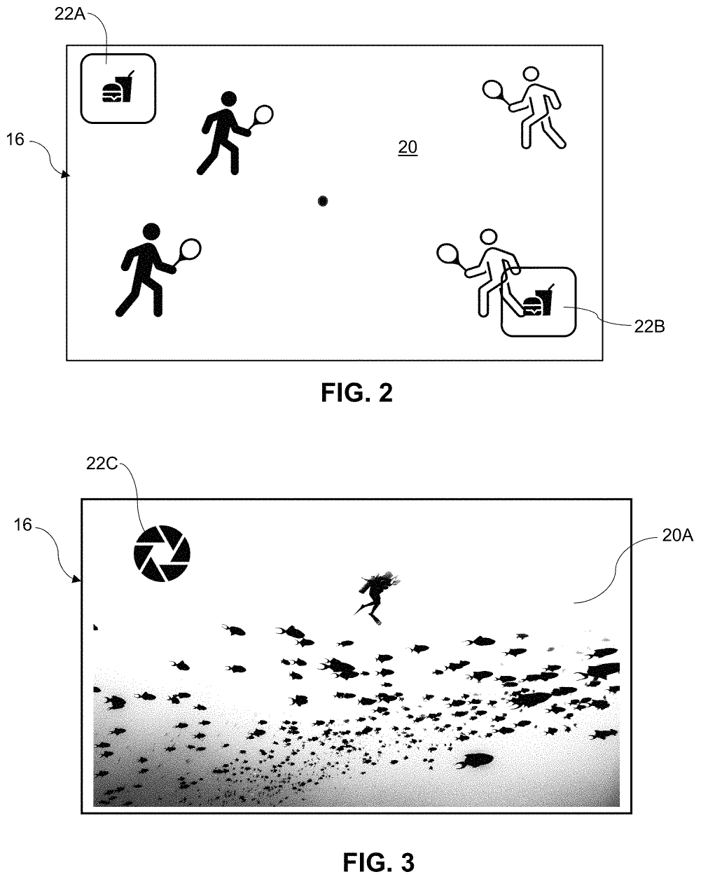

Turning to FIG. 2, the system controller 24 provides for positioning the auxiliary content visual representation 22A on an empty portion (i.e., without any foreground action/activity) of the main content 20. In an embodiment, the foregoing is computationally executed via artificial intelligence software allowing the system controller 24 to determine which portion or portions of the main content 20 are devoid of foreground activity or include only static images. In an embodiment, the system controller 24 computationally differentiate via Al processes between the foreground and the background portions of streamed main content 20.

In an embodiment, as shown in FIG. 2, the system controller 24 provides for multiple auxiliary content 22A and 22B (provided from the same or different auxiliary content controllers) to be simultaneously displayed via interface 16 along with the main content 20.

In an embodiment, and as shown in FIG. 2, the system controller 24 provides for displaying a translucent auxiliary content visual representation 22B which although superimposed on a portion of the main content 20 does not obscure this content (unlike in FIG. 1) as it is translucent, and the viewer can see through the image 22B to still be able to see portion of the main content 20 superimposed by the image 22B. In an embodiment, the auxiliary content image 22B is displayed as underlying the main content 20. Indeed, the portion of the main content 20 that the image 22B underlies is shown as being translucent thereby revealing that there is an image 22B thereunder which can be viewed.

User input commands can modify the auxiliary content visual representation from being a superimposed image to being an underlying image (as defined above) and from being a translucent image (as image 22B in FIG. 2) to an opaque solid image that obscures the main content 20 portion it overlies (or is superimposed on) as image 22 shown in FIG. 1. In an embodiment, the overlying/superimposed auxiliary content images 22, 22B can be repositioned via user input commands to “empty spots” of the main content 20 like image 22A in FIG. 2.

The simultaneously displayed auxiliary content can be an application icon. For example, in FIG. 3, a user interface 16 is shown streaming main content 20A and includes auxiliary content 22C in the form of an application icon allowing a user to access various apps such as purchasing apps or apps related to the content or apps preferred by the user. In an embodiment, the type of apps that appear as auxiliary content 22C can be predetermined via a user profile inputs or by the user's device 14 activity as monitored and registered by the system controller 24.

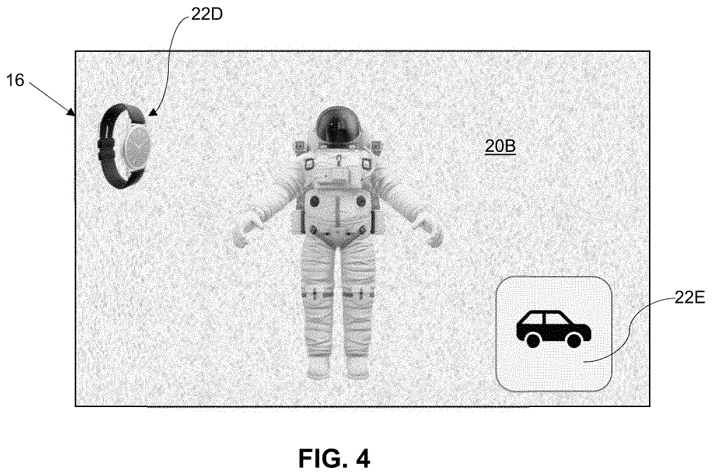

Turning to FIG. 4, there is shown an interface 16 displaying main content 20B as well as auxiliary content 22D. In this example, the auxiliary content image 22D is integrated into main content 20B. In an embodiment, the image 22D is a 2-D image or a 3-D image for example and forms part of the background scene and thus blends into the main content 20B. In an embodiment, the auxiliary content images 22D is visually conspicuous so as not to blend into the main content 20B. In an embodiment, the auxiliary content image 22D is static. In an embodiment, the auxiliary content image 22D is dynamic, such as moving image (rotating, re-sizing or moving positions along the interface 16), or an image that changes color and/or texture. Via user input commands, such as touch, voice, eyes orientation, cursor clicks and combinations thereof, the auxiliar content image 22D can be replaced by or can open an auxiliary interface image 22E superimposed on the main content 20B. In an embodiment, more than one image 22D can appear integrated into the main content 20B. In one example, a user can slide and drop one or more images 22D into the auxiliary interface 22E. In one example, the images 22D are articles and the interface 22E, when the articles 22D are dropped therein, provides item information and allows for purchasing.

The system S provided for a variety Pictures in Pictures (PIP) input command images for accessing merchant interfaces including splitting screens as provided herein.

The various features described herein can be combined in a variety of ways within the context of the present disclosure so as to provide still other embodiments. As such, the embodiments are not mutually exclusive. Elements of the embodiments and examples discussed can be combined within the context of the disclosure as those having skill in the art will readily appreciate. Moreover, the embodiments discussed herein need not include all of the features and elements illustrated and/or described and thus partial combinations of features can also be contemplated. Furthermore, embodiments with less features than those described can also be contemplated. It is to be understood that the present disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation. Hence, although the present disclosure has been provided hereinabove by way of non-restrictive illustrative embodiments thereof, it can be modified, without departing from the scope, spirit and nature thereof and of the appended claims.

What is claimed is:

1. A system for adding auxiliary content to main content for simultaneous display therewith via the same graphical user interface, wherein the main content and auxiliary content are hosted by one or more remote host controllers, the system comprising:
a user device in operative communication with the one or more remote host controllers and comprising an interface display for displaying the graphical user interface containing the simultaneously displayed main content and auxiliary content;
a system controller in operative communication with the user display device and the one or more remote host controllers, the system controller having a processor with an associated memory of processor executable code that when executed provides the system controller with performing computer-implementable steps comprising:
determining whether the main content is being displayed via the interface display;
selectively adding the auxiliary content to the displayed main content for simultaneous display therewith via the interface display, wherein the step of adding comprises at least one of:
superimposing the auxiliary content on the main content;
integrating the auxiliary content to the main content; and
providing for the auxiliary content to underly the main content and be visible therethrough; and
providing for the user to input a command via the user display device for modulating displaying of the auxiliary content via the interface display.

2. A system according to claim 1, wherein the computer-implementable steps further comprise:
positioning the auxiliary content on a selected portion of the main content.

3. A system according to claim 2, wherein the selected portion comprises a background of the main content or an area of the main content devoid of foreground activity.

4. A system according to claim 1, wherein the auxiliary content comprises a visual representation selected from the group consisting of an image, an input command image, an application icon, an interface, and any combination thereof.

5. A system according to claim 1, wherein the auxiliary content is smaller in size than the main content.

6. A system according to claim 1, wherein selectively adding the auxiliary content to the main content is provided without re-sizing the main content.

7. A system according to claim 1, wherein when the auxiliary content is superimposed on a portion of the main content, the auxiliary content covers and obscures the portion.

8. A system according to claim 1, wherein the auxiliary content is superimposed on a portion of the main content, the auxiliary content being translucent providing for the portion to be visible therethrough.

9. A system according to claim 1, wherein the computer implementable step of modulating displaying of the auxiliary content comprises removing the auxiliary content from the main content.

10. A system according to claim 1, wherein the computer implementable step of modulating displaying of the auxiliary content comprises repositioning the auxiliary content on the main content.

11. A system according to claim 1, wherein the computer implementable step of modulating displaying of the auxiliary content comprises splitting the graphical user interface into two sub-graphical user interfaces simultaneously displayed side by side via the interface display, wherein one of the two sub-graphical user interfaces comprises the main content and the other of the two sub-graphical user interfaces comprises the auxiliary content.

12. A system according to claim 1, wherein the computer implementable step of modulating displaying of the auxiliary content comprises switching the main content with the auxiliary content.

13. A system according to claim 7, wherein the computer implementable step of modulating displaying of the auxiliary content comprises transforming the auxiliary content from covering and obscuring the portion to being translucent and providing the portion to be visible therethrough.

14. A system according to claim 8, wherein the computer implementable step of modulating displaying of the auxiliary content comprises transforming the auxiliary content from being translucent to being opaque for covering and obscuring the portion.

15. A system according to claim 1, wherein the computer implementable step of modulating displaying of the auxiliary content comprises resizing the auxiliary content.

16. A system according to claim 1, wherein the computer implementable step of modulating displaying of the auxiliary content comprises replacing the main content.

17. A system according to claim 1, wherein the auxiliary content comprises one or more auxiliary content visual representations hosted on a respective one of the remote host controllers.

18. A system according to claim 1, wherein one of the one of more remote host controllers hosts the main content and another of the one or more host controllers hosts the auxiliary content.

19. A computer implementable method for adding auxiliary content to main content for simultaneous display therewith via the same graphical user interface, the method comprising:
providing an interface display for displaying the graphical user interface containing the simultaneously displayed main content and auxiliary content;
determining whether the main content is being displayed via the interface display;
selectively adding the auxiliary content to the displayed main content for simultaneous display therewith via the interface display, wherein the step of adding comprises at least one of:
superimposing the auxiliary content on the main content;
integrating the auxiliary content to the main content; and
providing for the auxiliary content to underly the main content and be visible therethrough; and
providing for the user to input a computer implementable command for modulating displaying of the auxiliary content via the interface display.

20. A computer-implementable method according to claim 19, wherein modulating displaying of the auxiliary content comprises a computer implementable step selected from the group consisting of:
removing the auxiliary content from the main content;
repositioning the auxiliary content on the main content;
switching the main content with the auxiliary content;
replacing the main content with the auxiliary content;
resizing the auxiliary content;
splitting the graphical user interface into two sub-graphical user interfaces simultaneously displayed side by side via the interface display, wherein one of the two sub-graphical user interfaces comprises the main content and the other of the two sub-graphical user interfaces comprises the auxiliary content;
transforming the auxiliary content from a visual representation covering and obscuring a portion of the main content superimposed thereby to being translucent and providing the portion to be visible therethrough
transforming the auxiliary from being translucent to being opaque.
